(19) United States
(12) Patent Application Publication
(10) Pub. No.: US 2009/0064107 A1
(43) Pub. Date: Mar. 5, 2009

(54) Token Transformation Profiles and Identity Service Mediation Node for Dynamic Identity Token

(75) Inventors: Eric M. Chan, Scarborough (CA); Laura M. L. Chan, Toronto (CA); Tinny M. C. Ng, Toronto (CA); Yu X. Zhu, Toronto (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,005

(22) Filed: Aug. 29, 2007

(51) Int. Cl. G06F 9/44

(52) U.S. Cl. 717/120

(57) ABSTRACT

A method comprising, sending a request from a requester to a provider via a bus, the request including a provider description and an identity token of a first type, wherein the bus includes an identity service mediation node having data associating a plurality of providers descriptions with corresponding identity token types, determining with the identity service node an identity token type associated with the provider description, updating the request with data including the identity token type associated with the provider description, sending the updated request with data including the identity token type associated with the provider description to an identity service via the bus, transforming the identity token of the first type into an identity token of the type associated with the provider description with the identity service, and sending the request including the transformed identity token to the provider via the bus.

### FIELD OF THE INVENTION

This invention relates generally to service oriented architecture computer systems, and particularly to methods and systems for dynamically converting requester tokens in service oriented architectures.

### DESCRIPTION OF BACKGROUND

The use of service oriented architecture (SOA) allows programmers to use modular components of software and string them together to produce larger software. The modularity of SOA decreases programming time and allows the economical design of software for a specific user. The modules also allow the software to be easily changed based on the needs of a user.

Often SOA systems include a security system that maintains the integrity of the SOA system. For example, when a requester in the SOA system makes a request for a specific service from a provider, the requester sends a passport (or token) to validate the request. However, the token types accepted by providers are not always the same as the token types used by a requester. Thus, the tokens must be converted into the proper format such that the requests may be processed by a provider.

One method for converting a requester token into the proper format for a provider is to program a requester such that the requester knows the type of token required for each provider. When a requester makes a request to a provider, the requester sends the request to an identity service with instructions for the type of token conversion required by the provider. The identity service converts the token, and forwards the request to the provider. However, using this approach can become difficult when making changes to the system because each requester must be updated each time a new provider is added.

Thus, it is desirable to use a method and system in a SOA that allows tokens in requests to be dynamically converted such that each requester does not require updating each time a new provider is added to the SOA.

### SUMMARY OF THE INVENTION

The shortcomings of the prior art are overcome and additional advantages are achieved through an exemplary method for dynamically transforming tokens in a service oriented architecture (SOA), the method comprising, sending a request from a requester to a provider via a bus, the request including a provider description and an identity token of a first type, wherein the bus includes an identity service mediation node having data associating a plurality of providers descriptions with corresponding identity token types, determining with the identity service node an identity token type associated with the provider description, updating the request with data including the identity token type associated with the provider description, sending the updated request with data including the identity token type associated with the provider description to an identity service via the bus, transforming the identity token of the first type into an identity token of the type associated with the provider description with the identity service, and sending the request including the transformed identity token to the provider via the bus.

An exemplary method for updating a service oriented architecture (SOA), the method comprising, adding a provider to the SOA, wherein the provider is communicatively linked to a bus, and the provider accepts an identity token of a first type, updating an identity service mediation node in the bus to include data associating the a provider description of the provider with identity tokens of the first type, wherein the identity service mediation node is operative to store data associating a plurality of provider designations with corresponding types of identity tokens, to receive a request including a provider designation and a requester identity token from a requester, and is further operative determine a type of identity token associated with the provider designation and update the request with data including the type of identity token associated with the provider designation, and determining whether an identity service includes a logic to transform a second type of identity token into the first type of identity token, and responsive to the determination, updating the identity service to include the logic, wherein the identity service is operative to receive the requester identity token and the data including the type of identity token associated with the provider designation, transform the requester identity token into the type of identity token associated with the provider designation, and send the transformed requester identity token to the provider via the bus.

An exemplary embodiment of a service oriented architecture system for dynamically transforming identity tokens comprising, a first requester communicatively linked to a bus and configured to send requests including an identity token of a first type, a first provider communicatively linked to the bus and configured to receive requests including an identity token of a second type, an identity service mediation node located in the bus, wherein the identity service mediation node is operative to store data associating the first provider with the second type of identity token and responsive to receiving a request for the first provider from the first requester including an identity token of the first type, updating the request to include data associating the request with the second type of identity token, an identity service communicatively linked to the bus, wherein the identity service is operative to receive the identity token of the first type and the data associating the request with the second type of identity token, and responsive to receiving an identity token of the first type and the data associating the request with the second type of identity token, transform the identity token of the first type into an identity token of the second type, and send the identity token of the second type to the first provider via the bus.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a diagram of an exemplary prior art SOA system using a point-to-point structure.

FIG. 2a illustrates an exemplary SOA system using a bus structure.

FIG. 2b is another illustration of the exemplary SOA system of FIG. 2a.

The detailed description explains the preferred embodiments of the invention, together with advantages and features, by way of example with reference to the drawings.

### DETAILED DESCRIPTION OF THE INVENTION

Methods and systems for dynamically converting requester tokens in service oriented architectures are provided. Several exemplary embodiments are described.

Service Oriented Architecture (SOA) systems may be used to provide software that is developed in modules. The use of modules allows programmers to quickly and economically produce software specific to the needs of a user. The programmers connect software modules easily without rewriting software that has been already coded into a module. Additionally, when a user requests changes to the software, a programmer may easily add or remove modules to meet the needs of the user.

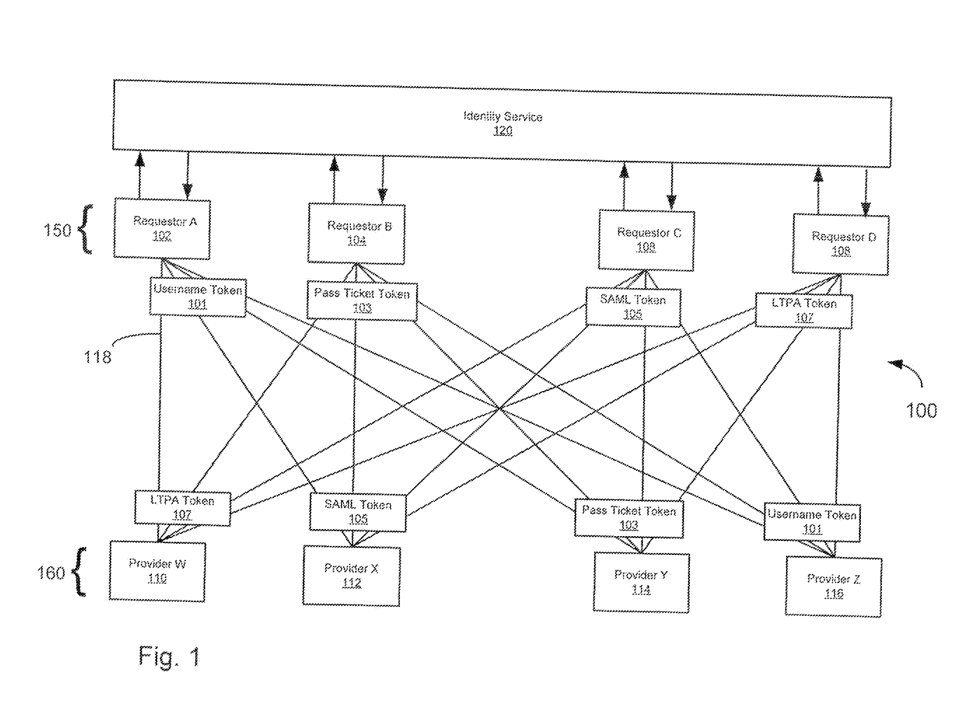

Referring initially to FIG. 1, there is shown one example of a prior art SOA system in which each of a plurality of requesters 150 is communicatively linked to each of a plurality of providers 160 via a point-to-point connection 118. Each requestor 150 is also communicatively linked to an identity service 120.

The system 100 has been programmed using SOA such that when modules are incorporated into the system 100, a plurality of requesters 150 are configured to send requests to a plurality of providers 160. Each of the plurality of requesters 150 is configured to send an identity token with a request to a provider for system security. Thus, when a provider 160 receives a proper identity token from a requestor 150, the provider 160 will be authorized to perform a service associated with the request from the requestor 150. In the illustrated example, each requestor 150 (for example, requestor A 102, requestor B 104, requestor C 106, and requestor D 108) is configured to send a different type of identity token, for example, a username identity token 101, a pass ticket identity token 103, a SAML identity token 105, and a LTPA identity token 107. Each provider 160 (for example, provider W 110, provider X 112, provider Y 114, and provider Z 116) is configured to receive a different type of identity token.

The type of identity token configuration is determined when the modules associated with the particular requesters 150 and providers 160 are programmed. The programmers of the modules in this SOA system have not used a single standard identity token type for all requesters 150 and providers 160. Thus, to incorporate modules that use a variety of identity token types, into a SOA system, an identity service 120 must be included in the SOA system to transform an identity token type sent by a requester 150 into the proper identity token type receivable by a provider 160.

For example, if a requestor A 102 sends a request for a service to a provider Y 114, the request will include an identity token formatted as a username identity token 101. To process the request, the provider Y 114 must first receive the identity token to verify that the request originated from an authorized requestor 150. In this example, the provider Y 114 is configured to only receive identity tokens formatted as pass ticket identity tokens 103. Thus, the username identity token 101 sent with the request must be transformed into a pass ticket identity token 103 such that the provider Y 114 may verify the identity and validity of the requester A 102, and process the request.

Each requester 150 includes data that associates each provider 160 with the corresponding identity token type receivable by the providers 160. Therefore, before the requester A 102 sends the request to the provider Y 114, the requester A 102 must use the data to determine the type of identity token receivable by the provider Y 114. In the illustrated example, the requester A 102 would determine from the data that provider Y 114 may only receive a pass ticket identity token 103. The requester A 102 would then send the username identity token 101 to the identity service 120 with instructions to transform the username identity token 101 into a pass ticket identity token 103. Once the transformed identity token is received, the requester A 102 may send the request that includes a pass ticket identity token 103 to the provider Y 114. The since the provider Y 114 is configured to receive a pass ticket identity token 103 type of identity token, the provider Y 114 may verify the pass ticket identity token 103 and proceeded to processing the request.

Using the point-to-point scheme illustrated in FIG. 1, each requester 150 must include data that associates each provider 160 with the proper type of identity token. Thus, when a programmer adds a new provider 160 to the SOA system 100, the programmer must update each requester 150 to include the proper associating data for the identity token corresponding to the new provider 160.

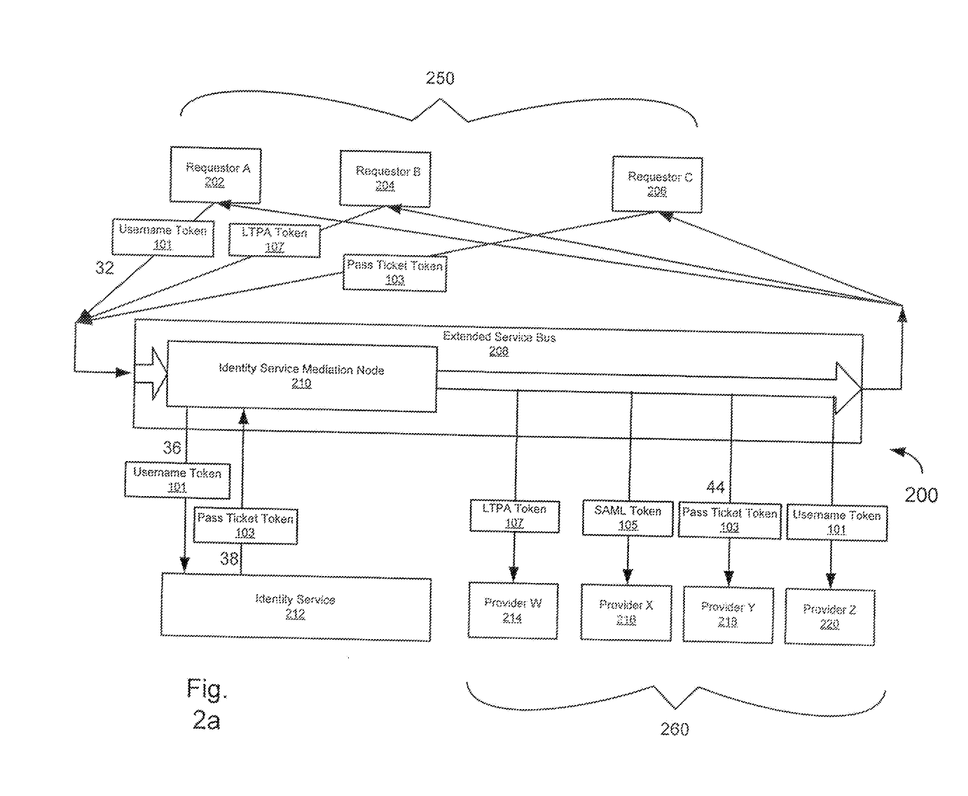

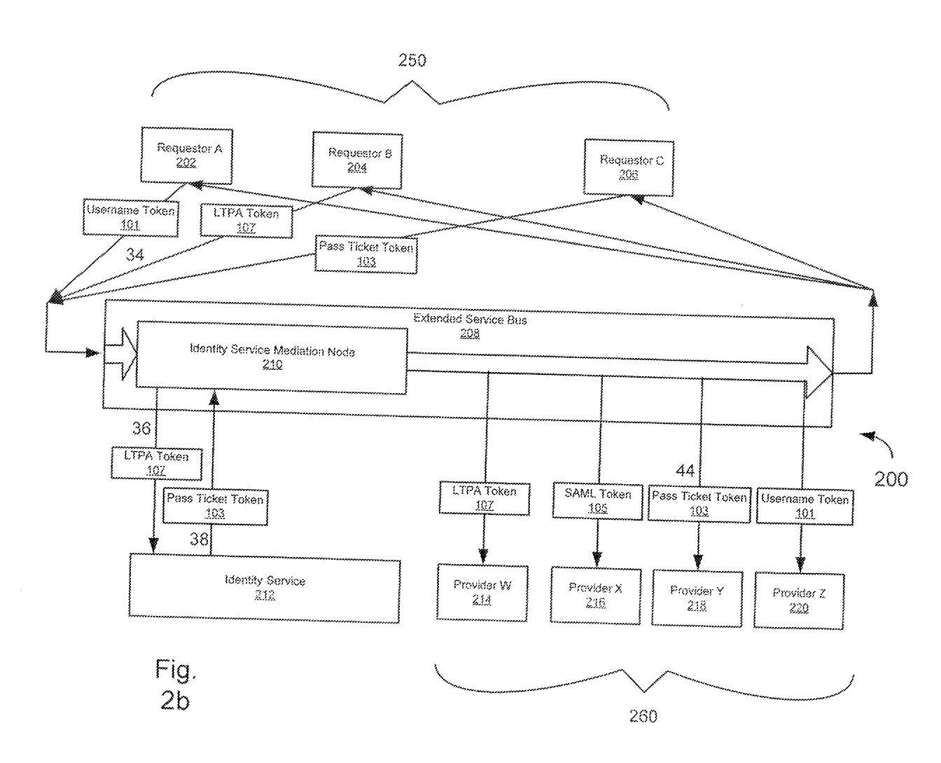

FIG. 2a illustrates an SOA system in accordance with an exemplary embodiment of the invention. In the illustrated embodiment, system 200 includes an extended service bus 208. A plurality of requesters 250 (requester A 202, requester B 204 and requester C 206) are communicatively linked to the extended service bus 208. The extended service bus (ESB) 208 includes an identity service mediation node (ISMN) 210. An identity service 212 communicatively links to the system 200 via the ESB 208. A plurality of providers 260 (provider W 214, provider X 216, provider Y 218, and provider Z 220) also communicatively link to the system 200 via the ESB 208. Each requester 250 and provider 260 are configured to send and receive one of a plurality of identification tokens, for example, the username token 101, the pass ticket token 103, the SAML token 105, and the LTPA token 107.

In operation, the system 200 allows the identity tokens sent by a requester 250 to be dynamically transformed with a request. In this regard, if for example, requester A 202 sends a request for service to provider Y 218, the request is sent to the provider Y 218 via the ESB 208. Since the requester A 202 is configured to send username identity tokens 101 and the provider Y 218 is configured to receive pass ticket identity tokens 103, the identity service 212 must transform the username identity token 101 into a pass ticket identity token 103. In the illustrated embodiment, the ISMN 210 allows the system 200 to dynamically transform the identity ticket.

Thus, when the request is send from requester A 202 to the ESB 208 via a communicative link 32, the request is processed by the ISMN 210. The ISMN 210 includes data that associates each provider 260 with the corresponding identity token type receivable by the providers 260. Therefore, when the requester A 202 sends the request to the provider Y 218, the ISMN 210 uses the data to determine the type of identity token receivable by the provider Y 218.

In the illustrated example, the ISMN 210 would determine from the data that provider Y 218 may only receive a pass ticket identity token 103. ISMN 210 would then send the username identity token 101 through the ESB 208 via a communicative link 36 to the identity service 212 with instructions to transform the username identity token 101 into a pass ticket identity token 103. Once the identity service 212 transforms the username identity token 101 into a pass ticket identity token 103 the pass ticket identity token is returned to the ISMN 210 and the ESB 208 via a communicative link 38. The ISMN 210 then attaches the pass ticket identity token 103 to the request. The request with the pass ticket identity token 103 is then sent to the provider Y 118 via the ESB 208.

This illustrated example may be repeated for additional requests. Thus, referring to FIG. 2b, requester B 204 may send a second request including a different type of identity token (i.e., a LTPA token 107) for service to provider Y 218 via a communicative link 34. The second request enters the ISMN 210 in the ESB 208 where the ISMN 210 would again determine that the provider Y 218 requires a pass ticket identity token 103. The ISMN 210 would send instructions to the identity service 212 via communicative link 36 to transform the LTPA identity token 107 into a pass ticket identity token 103. Once the identity ticket is transformed into a pass ticket identity token 103 the pass ticket identity token 103 is sent to the ESB via the communicative link 38 where it is sent to the provider Y 218 via the communicative link 44.

The dynamic transformation features of the system 200 allow programmers to add modules to the system 200 more easily and efficiently than the system 100. Thus, when a new provider 260 is added to the system 200 the data in the ISMN 210 is updated to include the proper identity token type that corresponds to the new provider 260. This effectively allows a programmer to avoid updating identity token data for the new provider 260 in each requester 250. Additionally, if a programmer adds a new requester 250 to the system 200, the programmer does not have to program the requester 250 with the data having the proper identity token type that corresponds to each of the providers 260 because the ISMN 210 should already include the necessary data. Therefore, as long as the programmer verifies that the identity service 212 contains the proper logic to transform all of the identity tokens in the system 200 and updates the data in the ISMN 210 to include each new provider 260, the system 200 may dynamically transform identity tokens in the ESB 208.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for dynamically transforming tokens in a service oriented architecture (SOA), the method comprising:
receiving a request from a requestor to a provider via a bus, the request including a provider description and an identity token of a first type, wherein the bus includes an identity service mediation node having data associating a plurality of providers descriptions with corresponding identity token types;
determining with the identity service node an identity token type associated with the provider description;
updating the request with data including the identity token type associated with the provider description;
sending the updated request with data including the identity token type associated with the provider description to an identity service via the bus;
transforming the identity token of the first type into an identity token of the type associated with the provider description with the identity service; and
sending the request including the transformed identity token to the provider via the bus.

2. A method for updating a service oriented architecture (SOA), the method comprising:
adding a provider to the SOA, wherein the provider is communicatively linked to a bus, and the provider accepts an identity token of a first type;
updating an identity service mediation node in the bus to include data associating the a provider description of the provider with identity tokens of the first type, wherein the identity service mediation node is operative to store data associating a plurality of provider designations with corresponding types of identity tokens, to receive a request including a provider designation and a requester identity token from a requester, and is further operative determine a type of identity token associated with the provider designation and update the request with data including the type of identity token associated with the provider designation; and
determining whether an identity service includes a logic to transform a second type of identity token into the first type of identity token, and responsive to the determination, updating the identity service to include the logic, wherein the identity service is operative to receive the requester identity token and the data including the type of identity token associated with the provider designation, transform the requester identity token into the type of identity token associated with the provider designation, and send the transformed requester identity token to the provider via the bus.

3. The method of claim 2, further comprising determining whether the identity service includes logic to transform a plurality of types of identity tokens into the first type of identity token, and responsive to the determination, updating the identity service to include the logic.

4. A service oriented architecture system for dynamically transforming identity tokens, comprising:
a first requester communicatively linked to a bus and configured to send requests including an identity token of a first type;
a first provider communicatively linked to the bus and configured to receive requests including an identity token of a second type;
an identity service mediation node located in the bus, wherein the identity service mediation node is operative to store data associating the first provider with the second type of identity token and responsive to receiving a request for the first provider from the first requester including an identity token of the first type, updating the request to include data associating the request with the second type of identity token;
an identity service communicatively linked to the bus, wherein the identity service is operative to receive the identity token of the first type and the data associating the request with the second type of identity token, and responsive to receiving an identity token of the first type and the data associating the request with the second type of identity token, transform the identity token of the first type into an identity token of the second type, and send the identity token of the second type to the first provider via the bus.

5. The system of claim 4, further comprising a plurality of requesters communicatively linked to the bus, wherein each requester is configured to send requests including an identity token of a type from a plurality of types of identity tokens.

6. The system of claim 4, further comprising a plurality of providers communicatively linked to the bus, wherein each provider is configured to receive requests including an identity token of a type from a plurality of types of identity tokens;

7. The system of claim 6, wherein the identity service mediation node is further operative to store data associating each of the plurality of providers with the type of identity token each of the plurality of providers is configured to receive.

8. The system of claim 6, wherein the identity service is further operative to receive the an identity token of a first type from the plurality of types of identity token and transform the identity token into an identity toke of a second type from the plurality of types of identity tokens.
